(19) United States
(12) Patent Application Publication
(10) Pub. No.: US 2026/0022998 A1
(43) Pub. Date: Jan. 22, 2026

(54) METHOD OF PROCESSING DUST COLLECTED ON A DUST FILTER OF A CONTINUOUS DUST MONITORING DEVICE FOR ANALYSIS

(71) Applicant: Commonwealth Scientific and Industrial Research Organisation, Acton, Australian Capital Territory (AU)

(72) Inventors: Yonggang JIN, Pullenvale, Queensland (AU); Bharath Kumar BELLE, Brisbane, Queensland (AU); Srinivasa Rao Balusu, Pullenvale, Queensland (AU); Hua GUO, Pullenvale, Queensland (AU)

(21) Appl. No.: 18/994,177

(22) PCT Filed: Jul. 13, 2023
(86) PCT No.: PCT/AU2023/050645

§ 371 Date: Jan. 14, 2025

(30) Foreign Application Priority Data
Jul. 15, 2022 (AU) 2022901987

(51) Int. Cl. G01N 1/40; B01D 39/20; G01N 21/35; G01N 23/207

(52) U.S. Cl. CPC G01N 1/4077; B01D 39/2017; G01N 21/35; G01N 23/207; G01N 2001/4088; G01N 2021/3595; G01N 2223/651

(57) ABSTRACT

The invention provides a method of processing dust collected on a dust filter of a continuous dust monitoring device for FTIR or XRD analysis, the method comprising: contacting the dust filter with a liquid carrier to selectively remove the dust from the dust filter, thereby producing a slurry comprising the dust in the liquid carrier; and filtering the slurry through a filtration unit comprising a silicon-free polymeric filter element, thereby retaining the dust on the polymeric filter element.

The present application claims priority from Australian provisional patent application No. 2022901987 filed on 15 Jul. 2022, the contents of which are to be understood to be incorporated into this specification by this reference.

### TECHNICAL FIELD

The invention generally relates to provides a method of processing dust collected on the dust filter of a continuous dust monitoring device for subsequent FTIR or XRD analysis. The invention also relates to a method of analysing dust collected on a dust filter of a continuous dust monitoring device by FTIR or XRD analysis, in particular to determine the crystalline silica content of the dust. The invention is particularly applicable for analysis of dust collected by a personal dust monitor (PDM) comprising a tapered element oscillating microbalance (TEOM), and it will be convenient to disclose the invention in relation to that exemplary embodiment.

### BACKGROUND OF INVENTION

Exposure to respirable crystalline silica (RCS) is well established as a risk factor for silicosis and lung cancer. In industrial workplaces where RCS is a hazard, such as coal mines, it is therefore critical to conduct respirable dust sampling to monitor the dose and composition of respirable dust in air breathed by workers. Historically, this has been performed via gravimetric sampling techniques.

Conventional gravimetric personal samplers direct a known volume of air from within a worker's breathing zone through a cyclone, which excludes larger, non-respirable particulates, and then through a filter containing a removable filter membrane to retain the respirable dust fraction. After a desired period of use, the filter membrane is removed from the sampler and the measured mass of retained dust is used to calculate the mass of respirable dust per unit volume of air. The dust retained on the filter membrane is then subjected to laboratory analysis to determine its crystalline silica (quartz) content. Typically, the polymeric filter membrane is first ashed to reduce interference from organic species in the dust sample and the ash is then redeposited on a further filter membrane suitable as a substrate for Fourier transform infrared (FTIR) and/or X-ray diffraction (XRD) analytical methods. Industry-standard methods for gravimetric sampling and analysis have been established by regulatory bodies such as the National Institute for Occupational Safety and Health (NIOSH, a US government agency) which specifies Methods 7603 and 7500 for FTIR and XRD analysis of crystalline silica in coal dust in its Manual of Analytical Methods.

A significant shortcoming of conventional gravimetric sampling is that it cannot provide immediate feedback on dust exposure risk. For this reason, substantial resources have been invested to develop continuous dust monitoring devices which provide real-time monitoring of dust exposure. The most successful approaches use resonant mass monitoring techniques, such as a tapered element oscillating microbalance (TEOM), wherein the dust filter of the monitoring device is oscillated at its natural resonance frequency in the sampling device. As the mass of the filter increases due to dust capture, the resonance frequency of the oscillating filter decreases. This correlation is used to calculate and track the amount of dust deposited on the filter in real-time.

An example of a continuous dust monitoring device in commercial use is the PDM3700 personal dust monitor (PDM), available from Thermo Scientific. The TEOM unit of such a device, schematically depicted in FIG. 1, includes inlet 100 through which air 102 comprising respirable dust particulates is drawn. Dust filter 104, located in inlet chamber 106, is mounted on tapered tubular element 108 which is fixed at its opposite end to base 110. The tapered tubular element can thus oscillate at a natural resonance frequency in the direction indicated by arrows 112a, 112b. The PDM electronics control and measure this oscillation, for example via interaction of electromagnetic drivers 114a, 114b with magnets 116a, 116b.

Dust filter 104 includes a hollow polymer body 118 configured to receive taped tubular element 108, glass fibre filter membrane 120 and polymer retaining ring 122 which seals filter membrane 120 to the rim of body 118. The three components are welded together to form a unitary assembly which is mountable on and detachable from tapered tubular element 108.

In use, air is drawn at a known flowrate from a worker's breathing zone into the PDM, size-selected in a cyclone to remove coarse particulates, and passed as air 102 into chamber 106, through dust filter 104, and out of the TEOM unit via tapered tubular element 118 and outlet 122. The respirable dust in air 102 is retained on filter membrane 120, thus increasing the mass of dust filter 104. This mass is monitored in real time by measuring the resonance frequency of tapered tubular element 108.

Personal dust monitors such as the PDM3700 are now in routine operation in many workplaces, including coal mines. While the real-time monitoring capability of these devices provides an advantage over traditional gravimetric samplers, they suffer from the significant disadvantage that the crystalline silica content of the dust retained on the filter cannot be analysed by traditional FTIR and XRD analysis methods, e.g. NIOSH Methods 7603 and 7500. Since the amount and composition of respirable dust particulates are both important factors, the use of PDM devices to date has not been able to provide a complete picture of dust exposure risk.

This issue arises from the construction and composition of the dust filter assembly used in PDM devices. Commercially available PDM dust filters, as described above, are not suitable for ashing because of the durable materials of construction, including glass fibres and fluoropolymers present in the filter membrane, and the significant mass of the multicomponent filter assembly by comparison to removable polymeric filter sheets used in traditional gravimetric sampling methods. Silicon-based components in the dust filter, including the glass fibres, would also contaminate the ash and may thus confound any analysis of crystalline silica in the dust.

A previous attempt to address this issue is described in U.S. Pat. No. 7,947,503. The approach described therein sought to modify the composition of the dust filter assembly (item 104 in FIG. 1), thereby rendering all components suitable for ashing. Thus, the filter membrane (item 120 in FIG. 1) was fabricated entirely from nylon or other organic polymers. Inorganic components such as TiO₂ pigments were also excluded from the polypropylene filter body and retaining ring (items 118 and 122 in FIG. 1). It was claimed that a respirable dust sample retained on such a modified dust filter could be analysed by ashing the entire filter assembly and then subjecting the ash to conventional FTIR or XRD analysis.

However, this approach still has a number of significant shortcomings. Firstly, the dust filter includes structural polymeric components which require extended time periods to ash. Secondly, the overall mass of the multicomponent dust filter is very high compared to the mass of retained dust, so that residual ash from the filter is more likely to introduce error to a dust analysis conducted on the ash. Thirdly, it is challenging to reconcile the competing technical requirements of the filter membrane (item 120 in FIG. 1). These requirements include: (i) a composition which is fully ashable and free of inorganic content which might confound the subsequent analysis, (ii) a sufficiently robust membrane construction to span the hollow body without support other than the retaining ring, and (iii) excellent dust filtering and dust retention capabilities during sampling. The approach described in U.S. Pat. No. 7,947,503 has not been commercially successful and alternative PDM filters are not available to replace the glass fibre filters currently in use. There is thus an ongoing need for methods of analysing dust collected in a PDM which do not rely on a redesign of the dust filter assembly.

Furthermore, it is desirable in some scenarios to avoid ashing the dust sample altogether. The ashing procedure used in standard analysis methods such as NIOSH Methods 7603 and 7500 is time-consuming and must frequently be conducted in an off-site analytical laboratory. Results generated using the above standard laboratory analysis are generally not available for several days to several weeks after sampling, which delays timely and effective intervention for engineering control of dust exposure. Earlier results might be obtained, without unacceptable impacts on accuracy, by conducting a direct-on-filter analysis of the sampled dust, for example with a field-based FTIR method. However, the dust filters of continuous dust monitoring devices (such as the PDM3700) are inherently unsuited for direct-on-filter analysis because the bulky filter assembly blocks IR beam transmission and the glass fibre filter contains silica, which would confound the RCS analysis. Moreover, the three-dimensional PDM filter assembly, whether sold commercially or modified as described in U.S. Pat. No. 7,947,503, is not physically compatible with analytical instruments configured to receive planar substrates.

There is therefore an ongoing need for new methods of processing dust collected on a dust filter of a continuous dust monitoring device for FTIR or XRD analysis, which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect the invention provides a method of processing dust collected on a dust filter of a continuous dust monitoring device for FTIR or XRD analysis, the method comprising: contacting the dust filter with a liquid carrier to selectively remove the dust from the dust filter, thereby producing a slurry comprising the dust in the liquid carrier; and filtering the slurry through a filtration unit comprising a silicon-free polymeric filter element, thereby retaining the dust on the polymeric filter element.

This advantageously provides a robust approach for analysing the composition of dust collected by a continuous dust monitoring device, such as a personal dust monitor (PDM) fitted with a glass fibre filter. The collected dust is transferred in a representative and selective manner to a substrate which is inherently suitable for subsequent analysis by FTIR or XRD. There is thus no need to redesign the dust filter, and indeed the methods of this disclosure are compatible with the glass fibre based dust filters already used in commercial PDM's for mining environments. The inventors have found that more than 80 wt. % of the dust collected on such dust filters may be recovered on the polymeric filter element and thus analysed to determine its crystalline silica content. Moreover, the dust can be analysed without interference by silicon (e.g. from glass fibres) or other inorganics present in the dust filter because the selective transfer of the dust to the silicon-free polymeric filter element avoids contamination of the dust sample with components of the dust filter.

The methods disclosed herein advantageously allow the user to combine compositional analytical results of sampled dust with the pre-existing advantages of real-time mass monitoring provided by a continuous dust monitoring device. In at least some embodiments, analysis of the dust transferred to the silicon-free polymeric filter element can be implemented using existing equipment and procedures in analytical laboratories already servicing many workplaces. In some embodiments, the dust transferred to the silicon-free polymeric filter element is analysed via a direct-on-filter approach. This is more suited to onsite implementation and may allow rapid turnaround times for the compositional analysis which better complement the inherently rapid (real-time) monitoring of dust mass exposure provided by continuous dust monitoring devices.

In some embodiments of the first aspect, the method further comprises analysing the dust while present on the polymeric filter element by FTIR or XRD analysis. In other embodiments, the method further comprises ashing the polymeric filter element to produce an ash comprising the dust and analysing the ash by FTIR or XRD analysis. In either case, analysing the ash by FTIR or XRD analysis may comprise quantifying an amount of crystalline silica in the dust.

In accordance with a second aspect the invention provides a method of analysing dust collected on a dust filter of a continuous dust monitoring device by FTIR or XRD analysis, the method comprising: contacting the dust filter with a liquid carrier to selectively remove the dust from the dust filter, thereby producing a slurry comprising the dust in the liquid carrier; filtering the slurry through a filtration unit comprising a silicon-free polymeric filter element, thereby retaining the dust on the polymeric filter element; and analysing the dust retained on the polymeric filter element by FTIR or XRD analysis.

In some embodiments of the second aspect, the dust is analysed while present on the polymeric filter element. In other embodiments, analysing the dust comprises ashing the polymeric filter element to produce an ash comprising the dust and analysing the ash by FTIR or XRD analysis. In either case, analysing the ash by FTIR or XRD analysis may comprise quantifying an amount of crystalline silica in the dust.

In some embodiments of the first and second aspects, the dust is coal dust.

In some embodiments of the first and second aspects, the dust filter comprises silicon, optionally present at least partially in glass fibre.

In some embodiments of the first and second aspects, the continuous dust monitoring device is a personal dust monitor (PDM) comprising a tapered element oscillating microbalance (TEOM).

In some embodiments of the first and second aspects, the polymeric filter element consists of one or more organic polymers. The one or more organic polymers may comprise at least one selected from the group consisting of polyvinyl chloride, polyvinyl chloride-acrylic copolymer, polyolefin, nylon, polyester and cellulose.

In some embodiments of the first and second aspects, the polymeric filter element is ashable.

In some embodiments of the first and second aspects, the polymeric filter element is a planar sheet, the planar sheet being removably insertable into the filtration unit.

In some embodiments of the first and second aspects, the liquid carrier is an organic solvent. The organic solvent may be an alcohol, for example isopropanol.

In some embodiments of the first and second aspects, contacting the dust filter with the liquid carrier comprises backflushing the liquid carrier through the dust filter from a reverse side of the dust filter to a dust-receiving side of the dust filter.

In some embodiments of the first and second aspects, at least 70 wt. %, or at least 80 wt. %, of the dust collected on a dust filter is retained on the polymeric filter element.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts the tapered element oscillating microbalance (TEOM) unit of a commercially available personal dust monitor, including its removable dust filter.

FIG. 2 schematically depicts an apparatus for backflushing a dust filter, as seen in FIG. 1, with a liquid carrier to selectively remove dust from the dust filter according to some embodiments of the invention.

FIG. 3 is a graph comparing the measurement of respirable crystalline silica content in coal dust recovered (i) by solvent backflush through a dust filter of a continuous dust monitoring device, according to the present disclosure, and (ii) from a gravimetric personal sampler.

### DETAILED DESCRIPTION

The present invention relates a method of processing dust collected on a dust filter of a continuous dust monitoring device for FTIR or XRD analysis. The method comprises a step of contacting the dust filter with a liquid carrier to selectively remove the dust from the dust filter, thereby producing a slurry comprising the dust in the liquid carrier. In a further step, the slurry is filtered through a filtration unit comprising a silicon-free polymeric filter element, thereby retaining the dust on the polymeric filter element. The dust retained on the polymeric filter element may then be analysed by FTIR or XRD analysis, in particular to determine the crystalline silica content of the dust.

### Continuous Dust Monitoring Device

The method of the present disclosure relates to the processing of dust collected in a continuous dust monitoring device. As used herein, a continuous dust monitoring device refers to a dust sampling device which provides real-time feedback on the mass of dust collected. A continuous dust monitoring device is thus distinguished from conventional gravimetric sampling devices which do not have real-time monitoring capabilities.

In some embodiments, the continuous dust monitoring device is a personal dust monitoring device, for example a personal dust monitor (PDM) such as the PDM3700 available from Thermo Scientific. Such devices are configured to be worn by a user and sample representative air from the breathing space of that user. However, the methods disclosed herein also extend to devices not configured for personal use, for example wall-mounted units or any other continuous dust monitoring devices for real-time monitoring of dust in air.

The continuous dust monitoring device may be equipped with a resonant frequency microbalance, which monitors the mass of dust collected on the dust filter by measuring a resonant frequency of the dust filter when oscillated. An example of a suitable resonant frequency microbalance is a tapered element oscillating microbalance (TEOM).

Optionally, the continuous dust monitoring device may include a cyclone to size-select dust particulates, so that dust particulates approximating the respirable dust fraction is collected on the dust filter. Other well-known components of continuous dust monitoring device, including pumps, sensors, electronics, etc are also expected to be present.

### Dust Filter

The dust to be processed is collected on a dust filter of the continuous dust monitoring device. As used herein, the dust filter includes both the porous filter membrane for trapping and retaining the dust and any associated components which together form the integral filter unit inserted into the continuous dust monitoring device and removed therefrom after the monitoring period. The dust filter may comprise a porous membrane, and the dust filter is configured to pass a stream of gas for analysis, typically air, through the porous filter membrane such that dust particles carried by the gas are retained in the porous membrane.

In some embodiments, the dust filter is non-ashable. This means that it cannot be ashed using standard equipment and procedures for dust analysis, for example as set out in NIOSH Methods 7603 and 7500. The dust filter may be non-ashable because it includes durable materials of construction such as glass fibres and/or fluoropolymers.

In some embodiments, the dust filter comprises silicon, for example in glass fibres present in the filter membrane. In some embodiments, the dust filter comprises other inorganic components, for example inorganic pigments such as TiO₂. The presence of silicon and other inorganic materials in the dust filter may confound conventional analyses of dust collected on the dust filter, whereas the methods of the present disclosure avoid or at least mitigate these difficulties.

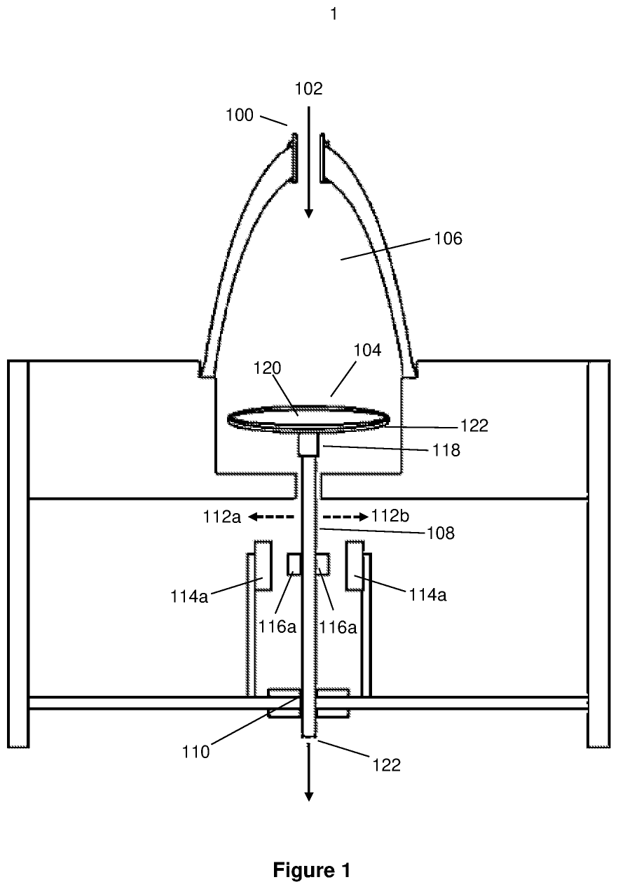

In some embodiments, as seen in FIG. 1, the dust filter comprises a hollow polymer body 118 configured to receive tapered tubular element 108, glass fibre filter membrane 120 and polymer retaining ring 122 which seals filter membrane 120 to the rim of body 118. The three components may be welded together to form a unitary assembly 104 which is mountable on and detachable from a tapered tubular element 108 of the continuous dust monitoring device.

### Dust

The dust collected on the dust filter may be any dust which is collectable in a continuous dust monitoring device, and in particular any air-born dust comprising respirable particulates of potential health concern if inhaled. In some embodiments, the dust comprises, or possibly comprises, crystalline silica such as quartz.

In some embodiments, the dust is coal dust, for example in air found in a coal mine. In other embodiments, the dust is produced in facilities for mineral or stone mining or manufacturing.

Contacting the Dust Filter with a Liquid Carrier to Selectively Remove the Dust

The methods of the present disclosure include a step of contacting the dust filter with a liquid carrier to selectively remove the dust from the dust filter, thereby producing a slurry comprising the dust in the liquid carrier. Typically, the dust filter is first detached from the continuous dust monitoring device before conducting this step.

The liquid carrier may generally be any liquid carrier capable of penetrating the dust filter membrane and carrying the dust particulates out of the filter. Typically, the liquid carrier is an organic solvent, preferably having a low normal boiling point (<100° C.) so that the solvent can be effectively removed from the dust by evaporation. The liquid carrier should have a suitable polarity to penetrate the dust filter membrane and to carry the dust particulates, for example including coal and silica particles, out of the filter. Suitable liquid carriers include alcohols such as isopropanol, ethanol and the like. In some embodiments, the liquid carrier is isopropanol which is used as a dust carrier in other dust analysis methods such as NIOSH Methods 7603 and 7500.

The dust filter is contacted with the liquid carrier under conditions suitable to selectively remove the dust from the dust filter. It is typically important for the subsequent analysis that dust removed from the filter is not contaminated with filter materials such as glass fibres. The inventors have found that there is a risk of such contamination if the dust filter is immersed in the liquid carrier and subjected to ultrasonication to facilitate dust removal. Thus, in some embodiments, the dust filter is contacted with the liquid carrier to remove the dust without sonicating the filter.

The dust may be removed from the dust filter by any suitable method which avoids unacceptable contamination of the dust sample, for example by flushing or washing the dust filter with the liquid carrier, or gently agitating the dust filter in the liquid carrier.

In some embodiments, the liquid carrier is backflushed through the dust filter from a reverse side of the dust filter to a dust-receiving side of the dust filter, i.e. opposite to the air flow during dust sampling. The inventors have found that this approach may be used to recover a high proportion of the dust retained on the dust filter without contamination.

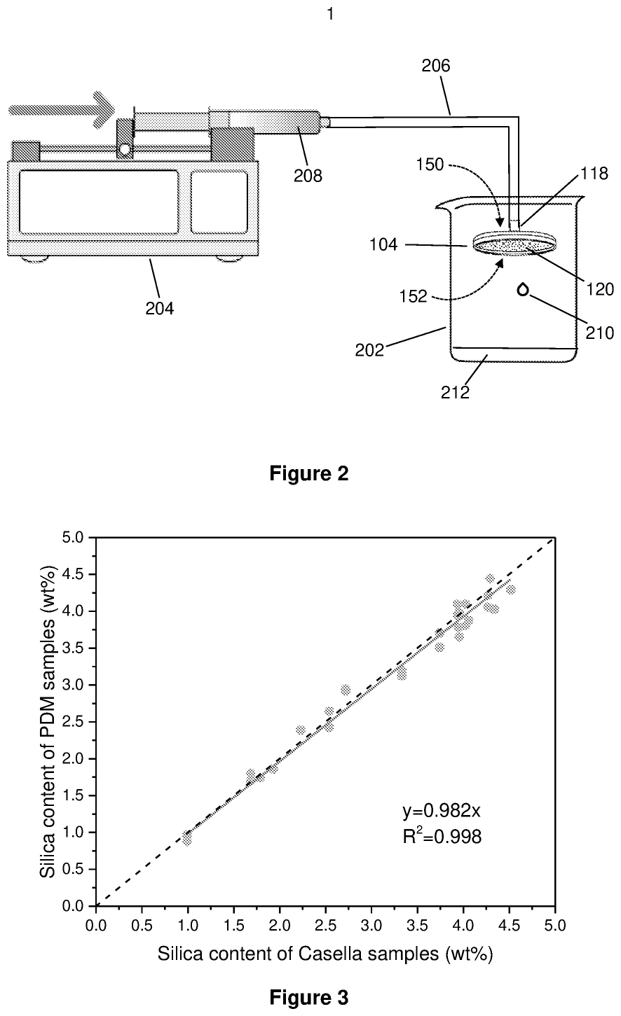

In one exemplary embodiment, as seen in FIG. 2, a dust filter 104 with dust retained thereon is removed from the PDM and clamped in an inverted configuration above a vessel 202, such as a beaker. Dust filter 104 is generally as described herein with reference to FIG. 1, and thus includes glass fibre filter membrane 120 (in which the collected dust is retained) and hollow polymer body 118. Dust filter 104 is then coupled to a syringe pump 204 via thin flexible tube 206, which frictionally seals into (or over) the orifice of hollow polymer body 118 configured for receiving the tapered tubular element of the PDM's TEOM. Isopropanol 208 is then dispensed from syringe pump 204 at a suitable flow rate. The isopropanol passes into dust filter 108 from reverse side 150, distributes evenly through the porosity of filter membrane 120, and carries the dust particles out of the filter membrane on the dust-receiving side 152 of the dust filter. Droplets 210 of the isopropanol, bearing the dust particulates, fall from the dust filter and collect in beaker 202 as slurry 212.

The flow rate of the isopropanol thus backflushed through the dust filter is selected to avoid excessive pressures in the filter membrane which might dislodge glass fibers. For a dust filter configured for use in a PDM3700 device, a suitable flow rate is about 1-2 ml/min. The total volume of isopropanol backflushed through the filter should be sufficient to recover all removeable dust from the dust filter. High recovery rates from a dust filter configured for use in a PDM3700 device have been obtained by passing 1-2 ml of isopropanol through the dust filter.

### Filtering the Slurry

The methods of the present disclosure include a step of filtering the slurry through a filtration unit comprising a silicon-free polymeric filter element, thereby retaining the dust on the polymeric filter element.

Filtration units suitable for filtering a slurry of dust in a liquid carrier are well-known in the field of dust analysis, for example as specified in NIOSH Methods 7603 and 7500. The filtration unit may thus be a vacuum filtration unit comprising a fritted glass base (optionally 25 mm, optionally a Millipore XX1012502 fritted glass base), a filter vacuum flask configured to receive the fritted glass base (optionally a Millipore XX1012506 vacuum filter funnel) and a glass funnel configured for clamping to the fritted glass base (optionally a custom-made glass funnel similar to a Millipore XX1002514 glass funnel but having an internal diameter of about 8-10 mm).

As used herein, a silicon-free polymeric filter element comprises a filter membrane suitable for trapping and retaining dust in the slurry, the filter membrane either entirely free of silicon or containing a negligibly low amount of silicon that does not interfere with subsequent analysis of the dust. Typically, the silicon-free polymeric filter element is configured as a thin, planar sheet of membrane material, the planar sheet being removably insertable into the filtration unit. In the filtration unit described above, such a filter element is placed over the fritted glass base and held in place when the glass funnel is clamped to the fritted glass base.

In some embodiments, the silicon-free polymeric filter element consists of one or more organic polymers. In other words, it contains no other materials of construction. Suitable organic polymers include those which are: (i) ashable, for example under the conditions set out in NIOSH Methods 7603 and 7500, and/or (ii) compatible with subsequent FTIR or XRD analysis by a direct-on-filter analysis approach. Non-limiting examples of suitable organic polymers may include polyvinyl chloride (PVC), polyvinyl chloride-acrylic copolymer, polyolefin, nylon, polyester, cellulose etc. Examples of particularly suitable materials include PVC and vinyl chloride-acrylonitrile copolymer.

It will be appreciated that the silicon-free polymeric filter element should be sufficiently porous to allow filtration. In some embodiments, therefore, the polymeric filter element comprises fibres of the one or more organic polymers. The polymeric filter element may be a nonwoven membrane comprising these fibres.

In some embodiments, the polymeric filter element as a whole is ashable, for example under the conditions set out in NIOSH Methods 7603 and 7500, thus allowing subsequent FTIR or XRD analysis of the dust via ashing and redeposition. In some embodiments, the polymeric filter element is a suitable substrate for FTIR or XRD analysis, for example as also set out in NIOSH Methods 7603 and 7500.

Suitable silicon-free polymeric filter elements include PVC filter membranes, for example having a 5 μm pore size, and vinyl chloride-acrylonitrile copolymer membranes, for example having a 0.45 μm pore size.

The slurry comprising the dust in the liquid carrier may be dispersed in the slurry prior to filtration. For example, the slurry may be subjected to ultrasonication to ensure that the dust is well-dispersed. The slurry comprising the dust may be filtered under conditions suitable to provide a high transfer and uniform distribution of dust particles onto the polymeric filter element. For example, after pouring the slurry from the slurry vessel into the filtration unit, the slurry vessel may be rinsed with further amounts of the liquid carrier and the rinsings are then added to the filtration unit. Furthermore, the filtration unit may be rinsed with further amounts of the liquid carrier to carry any dust particulates trapped on other surfaces onto the polymeric filter element.

After filtering the slurry, the polymeric filter element with dust retained thereon may be dried to evaporate the liquid carrier, and then weighed to determine the mass of dust redeposited on the polymeric filter element.

By careful application of the two-step method disclosed herein, it has been found that at least 70 wt. %, or at least 80 wt. %, of the dust collected on a dust filter may be recovered on the polymeric filter element. Such recoveries are sufficient to obtain a representative analysis of the respirable dust particulates collected in the continuous dust monitoring device.

### Analysis Methods

The methods of the present disclosure may include one or more further steps of analysing the dust on the polymeric filter element. In particular, the dust may be analysed by FTIR or XRD methods to determine the amount of crystalline silica (quartz) in the dust.

In some embodiments, the polymeric filter element with dust retained thereon is first ashed to produce an ash for analysis. The polymeric filter element should thus be selected for high ashability and to ensure that any residual ash does not interfere with the subsequent dust analysis. The ash is then analysed by FTIR or XRD analysis, which may involve redepositing the ash on a filter membrane suitable as a substrate in the analytical instrument of choice. Such methods of analysis are well-known in the field of dust analysis, for example as set out in NIOSH Methods 7603 (FTIR analysis) and 7500 (XRD analysis). Advantageously, embodiments of the invention which rely on ashing may thus be implemented using established analytical methods in laboratories already certified for such analysis.

In other embodiments, the polymeric filter element with dust retained thereon is subjected to a direct-on-filter FTIR or XRD analysis. In other words, the dust is analysed while still present on the polymeric filter element. For this approach, the polymeric filter element should be selected for its compatibility with the desired method of analysis. Advantageously, this approach may reduce the analysis complexity sufficiently to allow on-site implementation instead of sending the dust samples to an external analytical laboratory. The simpler approach may also facilitate faster turnaround times, so that the compositional analysis of the dust samples can be better matched with the inherently rapid (real-time) monitoring of dust mass provided by continuous dust monitoring devices. Thus, if a worker is exposed to a high overall dust hazard, based on mass and composition, appropriate interventions can be made at an early stage.

The inventors have demonstrated that direct-on-filter FTIR analysis may be used to accurately characterise the crystalline silica content of different respirable coal dust samples collected on a PDM once transferred to a suitable filter membrane according to the present disclosure.

### EXAMPLES

The present invention is described with reference to the following examples. It is to be understood that the examples are illustrative of and not limiting to the invention described herein.

### Example 1. Dust Sampling

Two types of respirable dust samplers were used to carry out pairwise sampling in parallel to obtain similar compositions of dust collected on the filter of each sampler. One sampler was a Thermo Scientific personal dust monitor (PDM3700) with a glass fibre filter (PDM filter). The other was a conventional gravimetric personal sampler (Casella Apex 2) with PVC filter of 25 mm in diameter (5 μm pore size). The air inlets of the two samplers were connected to a dust chamber. A mixture of coal powder smaller than 125 μm and respirable quartz standard (SRM 1878a) was fed into the chamber by compressed air to form a desired concentration of dust inside the chamber. The mixture of coal powder with a varied content of silica was sampled for different durations to obtain the filter-collected dust samples with a varied amount of dust loading and varied content of silica.

### Example 2. Flushing the Dust Filter of the PDM

The dust filter with coal dust collected thereon (as described in Example 1) was removed from the PDM3700 and clamped in an inverted configuration (dust-receiving side down) over a beaker (25 ml) as shown in FIG. 2. No dust was dislodged from the filter in this procedure. The dust filter was then coupled via a flexible hose to a syringe pump loaded with isopropanol (reagent grade). The syringe pump was then operated at a flow rate of 2 ml/min for 1 min to backflush isopropanol through the dust filter. It was observed that the liquid infused the entire filter membrane, carrying and dispersing the dust particles from the membrane into drops of liquid which dropped into the beaker. However, the flow rate was maintained at low values such that the membrane was not exposed to high pressures which might contaminate the sample with filter fibres.

### Example 3. Filtering the Slurry Comprising Dust from the PDM Dust Filter

The dust removed from the dust filter in Example 2 was then recovered on a PVC filter (25 mm diameter, 5 μm pore size) suitable for on-filter FTIR analysis by a modification of the procedure in NIOSH Manual of Analytical Methods Method 7603 (“NIOSH 7603”). This involved the following steps:
(1) Add 3 ml of isopropanol to the collected slurry of dust in the beaker to provide a slurry of about 5 ml total volume. The beaker was put in an ultrasonic bath to make the dust particles well dispersed in the solvent.
(2) Prepare a vacuum filtration apparatus for filtering the dust slurry after ultrasonic dispersion. The filtration apparatus consisted of a 25 mm fritted glass base (Millipore XX1012502) and 125 ml side-arm filter flask (XX1012506) and custom-made funnel similar to Millipore XX1002514 but with an internal diameter of 9.5 mm. Apply vacuum to the apparatus and then place a 25 mm glass fibre filter on the fritted glass base. Place two separate polyvinyl chloride (PVC) filters over the glass fibre filter. The top PVC filter was first weighed using a microbalance to allow the redeposited mass of dust to be calculated by subtraction. Position filter funnel on the fritted glass base, apply clamp and turn off vacuum.
(3) Add 3 ml of isopropanol to the funnel. As soon as ultrasonic dispersion is completed (step 1), add the dispersed dust slurry to the funnel. Then use 3 ml isopropanol to rinse the beaker twice and add rinsings to funnel. Apply vacuum and complete the filtration.
(4) Disassemble the filtration apparatus and remove the top PVC filter. Place this filter, with retained dust from the filtration step, in an oven at 50° C. for 15 minutes to evaporate all isopropanol. Remove the PVC filter from the oven and leave it to cool down to ambient temperature. Weigh the PVC filter and calculate the mass of redeposited dust on the PVC filter by subtracting its initial mass.

### Example 4. Filtering a Slurry Comprising Dust from the Conventional Gravimetric Personal Sampler (Comparative)

The 25 mm PVC filter containing dust collected in the conventional gravimetric personal sampler (Example 1) was placed in a beaker and 5 ml of isopropanol was added. The dust was thus removed from the PVC filter and dispersed in the isopropanol with sonication by placing the above beaker in an ultrasonic bath. After sonication, the PVC filter for dust sampling was removed from the beaker. The dust was then filtered and redeposited on a new PVC filter as per Example 3, steps (2)-(4). The mass of redeposited dust was calculated by weighing the blank PVC filter before redeposition and the filter with the redeposited dust after redeposition.

The purpose of detaching and redepositing the gravimetric sampling dust was to compare the quartz analysis results of coal dust processed according to the present disclosure and coal dust recovered from a conventional gravimetric sample collected in a parallel sampling. Both samples are expected to have the same concentration (wt. %) of silica in the collected dust.

### Example 5. On-Filter FTIR Analysis

The redeposited dust on PVC filters (as prepared in Examples 3 and 4) was subjected to direct-on-filter FTIR analysis to determine the silica content. The FTIR analysis method was similar to that used in NIOSH 7603, using peak height of 800 cm 1, baseline from ca. 820 to 670 cm⁻¹. A Thermo Scientific Nicolet iS50 FTIR spectrometer with an IR beam spot size of about 8 mm diameter was used. The circular area of redeposited dust is about 9.5 mm in diameter. An IR viewer was used to position the PVC filter in the sample holder to ensure that the IR beam was centred over the redeposited dust area.

### Results.

Four sets of dust samples of different composition, collected in Example 1 by pairwise sampling on the dust filters of the personal dust monitor (PDM) and the gravimetric personal sampler (GPS), were processed for analysis according to Examples 2 and 3 (PDM dust) and Example 4 (GPS dust). A high recovery of the dust was obtained for both approaches, in most cases greater than 80%.

The silica content of the recovered samples was then analysed using the methodology of Example 5, and the results are shown in Table 1 below. The content of quartz in each set of dust samples collected by pairwise sampling are very close. The comparative analysis demonstrates that processing dust from a personal dust monitor by flushing the filter with a solvent and filtering the resultant slurry, as disclosed herein, is an effective sample preparation approach for subsequent evaluation of the silica content.

TABLE 1

| | | Dust mass | Dust mass | | | Content of |
|---|---|---|---|---|---|---|
| Set of | Sample | collected | redeposited | Percentage | quartz | quartz in |
| dust | collected | on dust | on PVC | recovery | mass, | sampled |
| samples | on | filter (mg) | filter (mg) | (%) | μg | dust, % |
| 1 | GPS | 1.142 | 0.944 | 82.7 | 15.5 | 1.65 |
| 1 | PDM | 1.051 | 0.953 | 90.7 | 16.8 | 1.76 |
| 2 | GPS | 0.740 | 0.694 | 93.8 | 13.9 | 2.01 |
| 2 | PDM | 0.833 | 0.624 | 74.9 | 14.0 | 2.24 |
| 3 | GPS | 1.595 | 1.218 | 76.4 | 49.8 | 4.09 |
| 3 | PDM | 1.305 | 1.119 | 85.8 | 43.2 | 3.86 |
| 4 | GPS | 1.351 | 1.052 | 77.9 | 46.1 | 4.38 |
| 4 | PDM | 1.122 | 0.959 | 85.5 | 41.9 | 4.37 |

Multiple sets of parallel PDM (per Examples 2 and 3) and gravimetric samples (per Example 4) with a variety of dust-loading amounts (0.3-2.2 mg) and silica concentrations of (1.0-4.5 wt. %) were also processed using the developed methodology and analysed by FTIR (per Example 5). As shown in FIG. 3, the measured content of RCS in the PDM samples is very close to those of traditional gravimetric samples (“Casella samples”) collected in parallel sampling. The differences of the measured silica contents between PDM and gravimetric samples are less than 10% with the majority of variations below 5%. The FTIR technique is highly sensitive for silica quantification, and some of the measured samples have RCS contents as low as 5-10 microgram.

### Example 6. Comparison of Dust Extraction Methodologies

Redeposited dust, as produced by the methods of Examples 2-3 (i.e. via solvent backflush and filtration), was carefully analysed by scanning electron microscopy (SEM) and Energy Dispersive X-ray (EDX) analysis. Negligible glass fibre contamination was observed in the redeposited PDM dust sample.

Using a different approach, a dust filter with coal dust collected thereon (as described in Example 1) was removed from the PDM3700, submerged in isopropanol and subjected to ultrasonication (beaker placed in ultrasonication bath for 1-2 minutes) to detach the dust from the filter membrane into the isopropanol. The resultant slurry was then filtered through a PVC filter using the apparatus described in Example 3 to recover the dust. Good recovery of dust was obtained. However, significant contamination of glass fibres from the dust filter was observed in the redeposited PDM sample. A combined SEM-Energy Dispersive X-ray (EDX) analysis identified both silica dust particles and glass fibres in the redeposited dust samples.

The results demonstrate that the backflush method is highly effective in recovering dust from a dust filter comprising glass fibers without contamination by silicon-containing impurities such as glass fibers present in the dust filter.

Those skilled in the art will appreciate that the invention described herein is susceptible to variations and modifications other than those specifically described. It is understood that the invention includes all such variations and modifications which fall within the spirit and scope of the present invention.

1. A method of processing dust collected on a dust filter of a continuous dust monitoring device for FTIR or XRD analysis, the method comprising:
contacting the dust filter with a liquid carrier to selectively remove the dust from the dust filter, thereby producing a slurry comprising the dust in the liquid carrier; and
filtering the slurry through a filtration unit comprising a silicon-free polymeric filter element, thereby retaining the dust on the polymeric filter element.

2. The method according to claim 1, further comprising analyzing the dust while present on the polymeric filter element by FTIR or XRD analysis.

3. The method according to claim 1, further comprising ashing the polymeric filter element to produce an ash comprising the dust and analysing the ash by FTIR or XRD analysis.

4. The method according to claim 3, wherein analysing the ash by FTIR or XRD analysis comprises quantifying an amount of crystalline silica in the dust.

5. The method according to claim 1, wherein the dust is coal dust.

6. The method according to claim 1, wherein the dust filter comprises silicon.

7. The method according to claim 6, wherein the silicon is present in glass fibre.

8. The method according to claim 1, wherein the continuous dust monitoring device is a personal dust monitor (PDM) comprising a tapered element oscillating microbalance (TEOM).

9. The method according to claim 1, wherein the polymeric filter element consists of one or more organic polymers.

10-11. (canceled)

12. The method according to claim 1, wherein the polymeric filter element is a planar sheet, the planar sheet being removably insertable into the filtration unit.

13. The method according to claim 1, wherein the liquid carrier is an organic solvent.

14. (canceled)

15. The method according to claim 1, wherein contacting the dust filter with the liquid carrier comprises backflushing the liquid carrier through the dust filter from a reverse side of the dust filter to a dust-receiving side of the dust filter.

16. The method according to claim 1, wherein at least 70 wt. % of the dust collected on a dust filter is retained on the polymeric filter element.

17. A method of analysing dust collected on a dust filter of a continuous dust monitoring device by FTIR or XRD analysis, the method comprising:
contacting the dust filter with a liquid carrier to selectively remove the dust from the dust filter, thereby producing a slurry comprising the dust in the liquid carrier;
filtering the slurry through a filtration unit comprising a silicon-free polymeric filter element, thereby retaining the dust on the polymeric filter element; and
analysing the dust retained on the polymeric filter element by FTIR or XRD analysis.

18. The method according to claim 17, wherein the dust is analysed while present on the polymeric filter element.

19. The method according to claim 17, wherein analysing the dust comprises ashing the polymeric filter element to produce an ash comprising the dust and analysing the ash by FTIR or XRD analysis.

20. The method according to claim 17, wherein analysing the ash dust by FTIR or XRD analysis comprises quantifying an amount of crystalline silica in the dust.

21. (canceled)

22. The method according to claim 17, wherein the continuous dust monitoring device is a personal dust monitor (PDM) comprising a tapered element oscillating microbalance (TEOM).

23. The method according to claim 17, wherein the polymeric filter element consists of one or more organic polymers.

24-28. (canceled)

29. The method according to claim 17, wherein contacting the dust filter with the liquid carrier comprises backflushing the liquid carrier through the dust filter from a reverse side of the dust filter to a dust-receiving side of the dust filter.

30. (canceled)
